(19) United States
(12) Patent Application Publication
(10) Pub. No.: US 2018/0361496 A1
(43) Pub. Date: Dec. 20, 2018

(54) FEED SPEED REGULATION FOR ELECTROSLAG WELDING WITH MULTIPLE STRIPS

(71) Applicant: ESAB AB, Gothenburg (SE)

(72) Inventors: Hannes Hugo Raudsepp, Taby (SE); Ulf Nicklas Andrén, Rofors (SE)

(21) Appl. No.: 15/623,779

(22) Filed: Jun. 15, 2017

(51) Int. Cl. B23K 9/18; B23K 9/04

(52) U.S. Cl. CPC B23K 9/188; B23K 9/04

(57) ABSTRACT

Regulating the feed speed of multiple strips during electroslag strip cladding includes guiding a first strip and a second strip towards a work piece. A current is transferred to at least one of the first strip and the second strip to create a molten slag pool on the work piece sufficient for initiation of a cladding phase. A welding parameter associated with the cladding phase is measured and the first strip is fed towards the molten slag pool at a first variable feed speed based on the measuring of the welding parameter. The second strip is fed towards the molten slag pool at a second variable feed speed that is different from the first variable speed, but dynamically determined based on the first variable feed speed.

### TECHNICAL FIELD

The present disclosure is directed toward electroslag welding and, in particular, toward regulating strip feed speed for electroslag welding operations utilizing two or more strips, such as twin electroslag strip cladding.

### BACKGROUND

Electroslag strip cladding (ESSC) is a development of submerged arc strip cladding that is based on the ohmic resistance heating of an electrically conductive slag to create a pool of molten slag. During ESSC operations there is no arc between the strip electrode and the parent or base material (i.e., the work piece). Instead, heat generated by the pool of molten slag (which, in some instances, is referred to as a welding bath) melts the surface of a base material, an edge of a strip electrode submerged in the molten slag, and flux (which protects the molten slag pool and degasses a welding head being used for the ESSC process). In order to operate with the molten slag pool, which may be maintained at a temperature of approximately 2,300° C., a plating or cladding head (i.e., the head guiding one or more metal strips to the molten pool of slag) is usually a water-cooled, heavy duty head. The plating head also usually includes a motorizing driving roll for strip feeding.

The utilization a molten slag pool, as opposed to an arc, makes ESSC a reliable high deposition rate process suitable for cladding operations (which apply welded deposits over a large surface area). By comparison, submerged arc cladding creates significantly more dilution than the 7-10% dilution typically produced with ESSC (i.e., 50% more dilution than ESSC for the same heat input). Moreover, ESSC provides a higher deposition rate (i.e., the rate at which weld metal is actually deposited onto the work piece surface) and creates less penetration as compared to submerged arc cladding. For at least these reasons, ESSC may be preferable to submerged arc cladding when surfacing or cladding flat and curved objects such as heat exchangers, tubes, tube sheets and various pressure vessels. That being said, ESSC is still quite expensive and, thus, any improvements to the efficiency, productivity, dilution, etc. of ESSC are desirable.

More specifically, ESSC costs are typically driven by the cost of the equipment, most notably the plating head and feeding system, and the material utilized for the cladding. In fact, cladding techniques primarily exist because forming a part, vessel, plate, etc. entirely from a cladding material is often considerably more expensive than forming the part from an inexpensive material and cladding the part with the cladding material. Consequently, any developments in equipment or feeding systems that increase efficiency, quality, productivity, or otherwise minimize the amount of time and material required for cladding are highly desirable.

For example, in order to increase productivity, some cladding heads now accommodate two strips and introduce both strips into the same molten slag pool. Introducing two strips into the molten slag pool may extend the length of the molten slag pool (i.e., the introduction of a second strip may extend a slag pool approximately 20-35 mm) so that the molten slag pool begins to solidify approximately 20-25 after the trailing strip (i.e., the second strip). This may encourage the formation of flat beads and proper links during ESSC. Moreover, a head that accommodates two strips may increase the deposition rate (thereby increasing productivity), decrease dilution, and allow for unique cladding compositions (i.e., by mixing different strips).

However, the introduction of a second strip may also create productivity issues associated with feeding two strips at once. For example, currently, plating heads that accommodate two strips feed the strips at the same rate, which may not maximize the efficiency and productivity of the dual strip ESSC process. Consequently, developments in feeding systems that increase efficiency, productivity (i.e., by increasing the weld speed and/or deposition rate), or otherwise minimize the amount of time and material required for cladding with multiple strips are desired. Developments that improve weld quality (i.e., by improving the composition, control over the composition, etc.) are also desirable.

### SUMMARY

The present disclosure is directed toward feed speed regulation for electroslag welding, or more specifically feed speed regulation for electroslag strip cladding with multiple strips. The invention can be embodied as method, a system, an apparatus, and executable instructions in a computer-readable storage media to perform the method.

According to at least one example embodiment, regulating the feed speed of multiple strips includes guiding a first strip and a second strip towards a work piece. A current is transferred to at least one of the first strip and the second strip to create a molten slag pool on the work piece sufficient for initiation of a cladding phase. A welding parameter associated with the cladding phase is measured and the first strip is fed towards the molten slag pool at a first variable feed speed based on the measuring of the welding parameter. The second strip is fed towards the molten slag pool at a second variable feed speed that is different from the first variable speed, but dynamically determined based on the first variable feed speed.

### BRIEF DESCRIPTION OF THE SEVERAL VIEWS OF THE DRAWINGS

FIG. 1 is a diagram illustrating a cladding environment in which the techniques presented herein may be employed to clad a work piece, according to an example embodiment.

FIG. 2 is a diagram illustrating the work piece of FIG. 1 in further detail.

FIG. 3 is a left side view of an apparatus with which the techniques presented herein may be employed, according to an example embodiment.

FIG. 4 is a high-level flowchart illustrating a method for regulating feed speed while electroslag strip cladding with multiple strips, according to an example embodiment.

FIGS. 5 and 6 are diagrams illustrating relationships between a feed speed of a first or leading strip and a feed speed of a second or trailing strip, according to example embodiments.

FIG. 7 is a block diagram depicting a computer system upon which the techniques presented herein may be implemented, according to an example embodiment.

Like numerals identify like components throughout the figures.

### DETAILED DESCRIPTION

The techniques presented herein regulate the feed speed of strips for electroslag strip cladding (ESSC) processes utilizing multiple strips. These techniques ensure that any trailing strips (i.e., a second strip, third strip, or any strip after the first or leading strip) are properly positioned during the cladding process and, thus, improve the quality of the welds formed during an ESSC process. Regulating the feed speed may also provide more fine-tuned control over the thickness of the cladded layer and/or the composition of the cladded layer, which may create more consistency in both the thickness and composition over the length and/or area of the cladding, even when disturbances impact the weld created by the leading strip. By comparison, if an ESSC processes utilizes multiple strips without the regulation techniques provided herein (i.e., by running two strips at fixed and/or identical speeds), the ESSC process will not compensate for variations or disturbances occurring with the leading strip. In these instances, the resultant cladded layer may, in at least some areas, have an unacceptable thickness and/or chemical composition and further cladding operations and/or additional material may be required to cure the deficiencies (at an added cost).

Put another way, the techniques presented herein control the feed speed of at least two strips. The feed speed of the first strip is controlled based on a measured welding parameter and the feed speed of any additional strips is dynamically controlled based on the feed speed of the first strip. As is explained in further detail below, the feed speed of a trailing strip is different from the feed speed of the first or leading strip and may be controlled in real-time or with a slight delay, such as 100-500 ms.

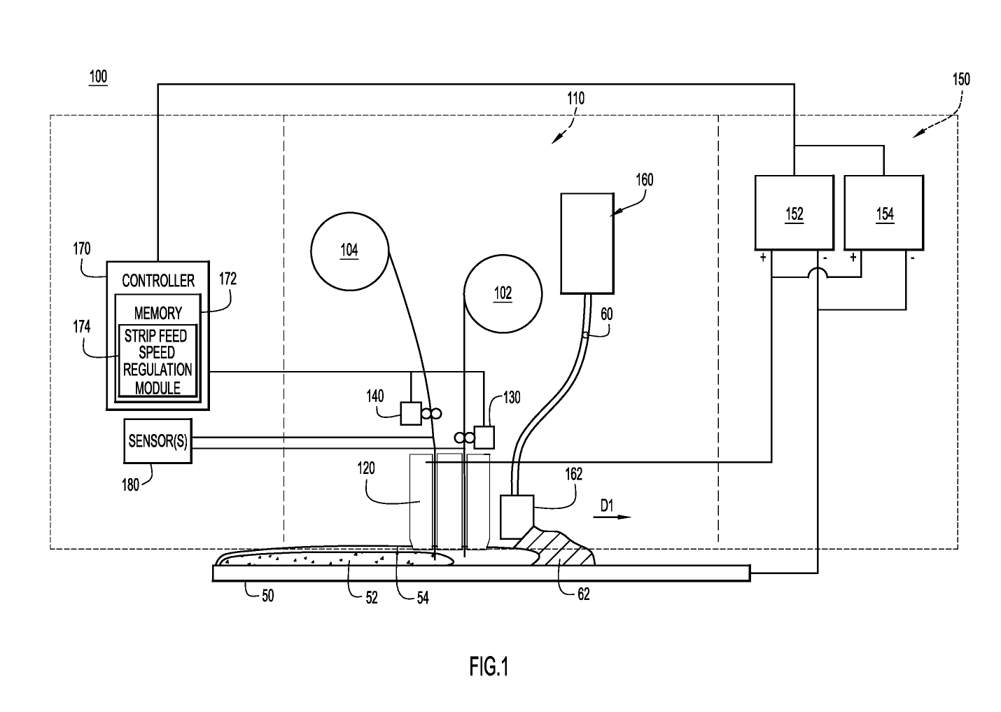

Now turning to FIG. 1 for a description of an example cladding environment 100 in which the techniques presented herein may be employed. In environment 100, various components of a cladding apparatus 110 are illustrated performing ESSC operations on a work piece 50. The apparatus 110 is a twin ESSC apparatus 110 (i.e., a twin ESSC plating or cladding head) and thus, is configured to guide or feed a first strip of cladding material 102 and a second strip of cladding material 104 towards the work piece 50. More specifically, in the depicted embodiment, the apparatus 110 includes a first strip feeder 130 that is configured to feed the first strip 102 to a contact jaw 120 and a second strip feeder 140 that is configured to feed the second strip 104 to the same contact jaw 120. The contact jaw 120 then guides strips 102 and 104 towards the work piece 50. However, in other embodiments, the strips need not be fed to the same contact jaw (or even be fed through the same cladding head) and, instead, may be fed to separate jaws (or heads). Along the same lines, in other embodiments, that apparatus may guide or feed more than two strips to the work piece 50. In fact, in some embodiments, any number of strips may be fed to any number of jaws/heads, with any combination of strips being fed to any of the jaws/heads (i.e., two strips for each of two heads that each include a single jaw).

In the depicted embodiment, strips 102 and 104 are arranged as “twin strips” because the strips are fed in parallel, as a double strip arrangement. However, the term parallel is not intended to imply that strips 102 and 104 are fed at the same rate by their respective feeders 130 and 140. Instead, as is explained below, strips 102 and 104 may be fed at different rates. In order to feed strips 102 and 104, feeders 130 and 140 may each include any parts or components that move strips 102 and 104 towards the work piece 50 (via the jaw 120). For example, feeders 130 and 140 may include grooved wheels driven by a driving unit, such as an electric motor. In embodiments utilizing grooved wheels, two grooved wheels may engage either side of each strip and rotate in opposite directions to move a strip towards the work piece 50. The grooved wheels may be coupled to driving motors via any desirable drive shaft, power train, gearing arrangement, or other such mechanical coupling that allows rotational energy to be imparted to the feeders.

Moreover, in the depicted embodiment, the first strip of material 102 and the second strip of material 104 are each provided as spools or coils of cladding material (i.e., spools of metal strips with a width of 90 mm and a thickness of 0.5 mm). Consequently, the first feeder 130 and second feeder 140 unwind or unspool the first strip 102 and the second strip 104 as the feeders 130 and 140 feed strips 102 and 104 to the work piece 50 via the contact jaw 120. Although not shown, in some embodiments feeders 130 and/or feeder 140 may include or be coupled to a straightener or straightening unit configured to straighten and/or align a strip as it is drawn from its coil/spool (i.e., as strip 102 or 104 approaches grooved wheels of feeder 130 or 140, respectively). However, in other embodiments, the strips can be fed from any desirable reservoir and feeders 130 and 140 need not unwind or unspool strips 102 and 104 while feeding the strips.

Once strips 102 and 104 are fed to the contact jaw 120, the contact jaw 120 aligns strips 102 and 104 in the welding direction D1 so that the apparatus guides strips 102 and 104 to the same portion of the work piece 50 as the welding operations move in the welding direction D1. That is, strips 102 and 104 are spaced a distance from each other in the welding direction D1, insofar as “welding direction” is the direction in which a weld is intended to run (i.e., the welding direction is the direction of movement of a cladding head). Consequently, the first strip 102 may be referred to as the leading strip 102 and the second strip 104 may be referred to as the trailing strip 104. However, in other embodiments, two or more strips can be arranged in various settings or formations. For instance, strips can be disposed along an axis that is perpendicular to the welding direction D1, spaced different distances from each other in the welding direction, or a combination thereof.

In the event two or more strips are spaced along an axis that is perpendicular to the welding direction D1 (i.e., spaced along a “transverse axis”), the strips may be positioned side by side, for example, to clad a wide span at once. By comparison, when the strips are aligned in the welding direction (like strips 102 and 104), the strips may perform different roles in a single cladding pass and/or form a cladding layer with a mixed composition (i.e., if the different strips are different materials). Still further, in some embodiment, a plurality of strips may be arranged in a grid-like arrangement so that at least some of the plurality of strips are spaced along a transverse axis and other strips are aligned in the welding direction D1 (i.e., to provide a specific welding composition over a wide span).

Still referring to FIG. 1, the apparatus 110 also includes a flux hopper 160 that is a repository for flux 60 and is configured to selectively deliver flux 60 to a flux drop 162 disposed adjacent to the contact jaw 120. Fluxes are generally granular fusible minerals typically containing oxides of manganese, silicon, titanium, aluminum, calcium, zirconium, magnesium and other compounds such as calcium fluoride. The role of the flux 60 in ESSC is described in further detail below, but, generally, the flux 60 helps to produce a metal weld 52 with a specific chemical composition and specific mechanical properties under a layer of slag 54. That is, the flux 60 is specially formulated to be compatible with a given strip or strips of cladding material so that the combination of flux and the strip(s) produces desired mechanical properties. In the depicted embodiment, flux 60 is delivered (i.e., by a nozzle of the flux drop 162) on the leading edge of the contact jaw 120 to produce a protective layer 62 over a molten slag pool, as is described in further detail below. Additionally or alternatively, flux may be delivered to the trailing edge of the contact jaw 120 to provide a layer of flux over any molten slag included above the metal weld 52 (i.e., the assembly 110 may include a second or repositioned hopper 160 and drop 162).

The apparatus 110 also comprises a power source 150, a controller 170, and one or more sensors 180. These components are each shown in dashed boxes connected to the dashed box of apparatus 110 because these components may be included in apparatus 110 (i.e., included during manufacturing of apparatus 110) or connected thereto (i.e., retrofitted to the apparatus 110 and/or connected via a wired or wireless connection). For example, the operations of controller 170 may be executed by components included in the power source 150 (i.e., the controller 170 may be a user interface and the power source 105 may regulate feed speed of strips 102 and 104). Each of these components is addressed in turn below.

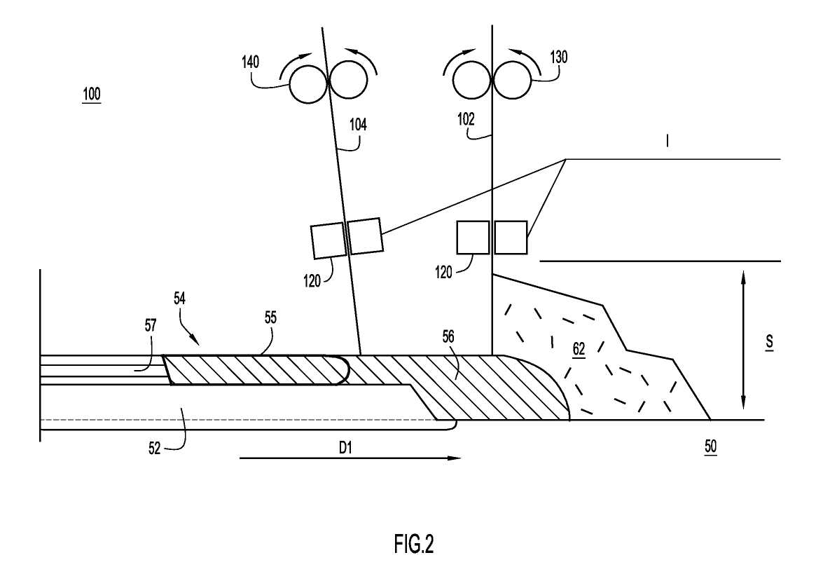

First, the power source 150 may be included in or connected to the apparatus 110 and may include any number or type of power sources, such as a welding converter, a welding transformer, a rectifier, a thyristor controlled rectifier or an inverter. As an example, power source 150 may include two parallel direct current (DC) power sources 152 and 154 that are each connected to the assembly 110. Regardless of how the power source 150 is provided, the power source 150 provides a current to the contact jaw 120 that flows into any strip(s) fed therethrough. The current is transferred to the entire surface area of the strip(s) in contact with the contact jaw 120 and, importantly, the current is applied individually to each strip of material passing through a cladding head. However, since the current is from a single source (even if the source comprises multiple components in parallel, like source 150), each strip receives the same magnitude of current. That is, strip 102 and 104 may receive approximately equal amounts of current individually (dependent on localized resistance levels in the molten slag). The current from each strip passes into the layer of electrically conductive slag 54 and, as is described in further detail below in connection with FIG. 2, the resistance of the slag 54 generates heat as the slag 54 receives current to effectuate the cladding process (i.e., the temperature of the slag adjacent the strip(s) providing current may be approximately 2,300° C.).

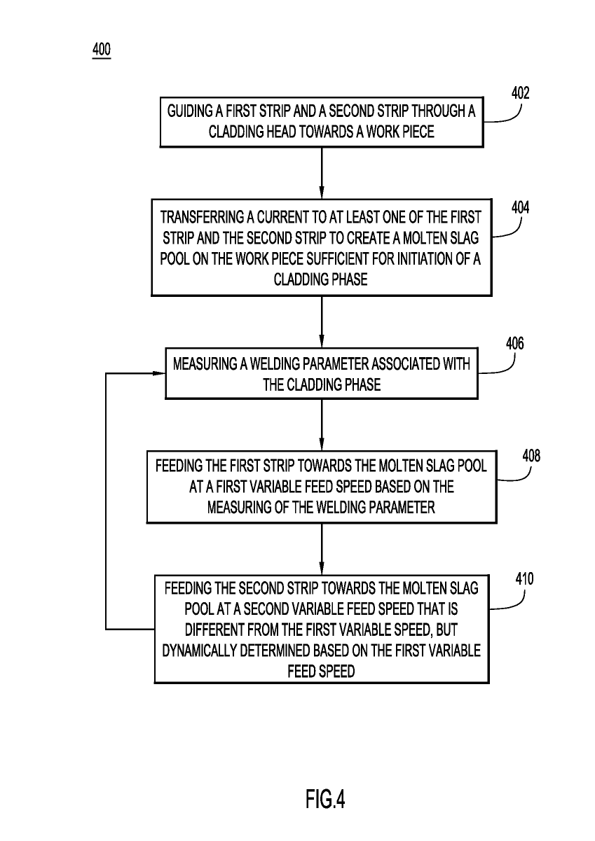

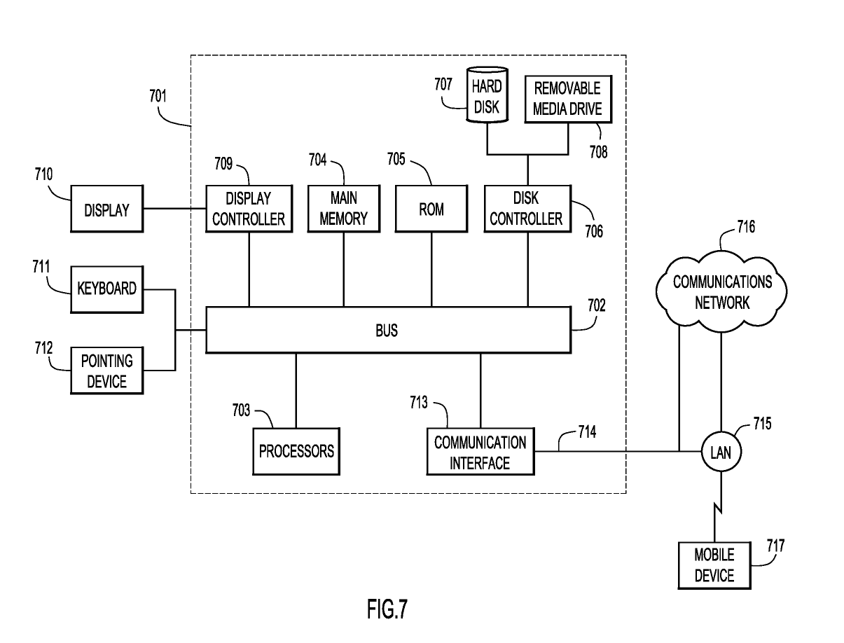

Second, the controller 170 is connected to the apparatus 110 and configured to control the first feeder 130 and the second feeder 140 in the manner described below in connection with FIGS. 4-6. More specifically, the controller 170 includes a memory 172 with a strip feed speed regulation module 174 and the strip feed speed regulation module 174 is configured to perform the operations discussed below in connection with FIGS. 4-6. In some embodiments, the controller 170 is local to the apparatus 110; however, in other embodiments, the controller 170 may be remote from the apparatus 110 and may be connected thereto via a network connection (i.e., a network connection formed by a communication interface included in the controller 170, as is described in further detail below in connection with FIG. 7). An example computing device that is representative of controller 170 is described below in connection with FIG. 7.

Third, the apparatus 110 may include or be coupled to one or more sensors 180. The sensor(s) are configured to measure the feed speed of at least the leading strip 102, but may also measure the feed speed of two or more strips, such as the leading strip 102 and the trailing strip 104. The sensor(s) 180 may measure the feed speed by measuring the speed with which a strip passes through the contact jaw 120, the speed with which a spool of the strip unwinds (i.e., a pulse sensor may count rotations of a strip coil), or any other parameter that is indicative of speed, such as motor parameters (i.e., motor parameters of motors in feeders 130 and 140), welding current, etc. Sensor(s) 180 may also measure or monitor any welding parameters, which are described in further detail below, including voltage, current, and other electrical parameters. For example, sensor(s) 180 may include one or more shunts in the power source to measure electrical parameters. The sensor(s) 180 may send any data to the controller 170 so that the controller 170 can determine a feed speed of one or more strips and/or any welding parameters. Information measured or collected by sensor(s) 180 is advantageously sent to the controller as soon as it is measured/collected, to prevent unnecessary delays in feed speed regulation/adjustment.

Now referring to FIG. 2, but with continued reference to FIG. 1, the apparatus 110 is generally configured to clad a work piece 50 with at least one of the first strip 102 and the second strip 104 in accordance with ESSC principles. That is, the physical principles that control the ESSC processes effectuated by assembly 110 are substantially the same as the physical principles used for known ESSC methods, except, here, current is delivered to the strips individually and the feed rates of the strips are precisely controlled to control the rate at which the known physical principles create a cladded surface (i.e., the welds are controlled based on feed rate of the strips).

By way of example, initially, the flux drop 162 releases flux 60 and a molten slag pool 56 is formed from the first strip 102, the work piece 50, and pulverized flux 60. Once the slag pool 56 is large enough for ESSC operations (i.e., once the “stick out” of the slag pool, which is illustrated as “S” in FIG. 2, is sufficient to extinguish an electrical arc used to initially create a molten slag pool), the apparatus 110 can begin cladding operations. That is, once the slag pool is large enough, the apparatus 110 can move in the welding direction D1 and/or the work piece 50 can be moved in direction opposite to D1 to initiate ESSC operations. However, this start-up process is described only by way of background and it is to be understood that the techniques presented herein are intended for use during a welding or cladding phase, which may be a phase during which cladding action is carried out. That is, the welding phase may be the phase between a start-up phase (creation of the molten slag pool and stabilization of welding parameters) and a stop phase (termination of the welding process).

During ESSC operations, current (shown as “I”) is introduced to the first strip 102 and second strip 104 at the contact jaw 120. The leading strip 102 is then brought into contact with the slag layer 54 and the current flows through the first strip 102 strip and into the layer of electrically conductive slag 54. More specifically, the current flows through the first strip 102 into a molten portion 56 of the slag layer 54. The resistance of the molten slag 56 generates heat that keeps the welding process going (i.e., the slag temperature remains at approximately 2,300° C., at least adjacent the strips). Consequently, as the ESSC operations proceed in the welding direction D1, the first strip 102 and work piece 50 are melted by the molten slag pool 56 and form a molten metal that is eventually deposited on the work piece 50 as a metal weld 52. The flux 60 also melts, at least in part, as the first strip 102 and work piece 50 are melted, creating the protective layer of slag 54 over the metal weld 52. However, at least a portion of the slag layer 54 that is extending over the weld is molten slag, as indicated at 56.

That is, molten slag 56 extends over a molten metal weld 52, so that the molten slag 56 includes a portion above the metal layer 52 and a molten slag pool at the leading edge of the metal weld 52. Eventually, the molten slag layer 56 above the metal weld 52 solidifies, as is shown at 57; however, in the depicted embodiment, the second strip 104 is quickly introduced to (i.e., incorporated or mixed into) the molten slag 56 before the molten slag 56 hardens (as indicated at 55). In fact, the trailing strip 104 actually rides on top of the slag layer 54 and since current is running through the second strip 104, the second strip 104 extends the length of the molten slag 56. For example, in the depicted embodiment, the molten slag 56 may begin to solidify approximately 50 mm-150 mm after the second strip, or even 100-200 mm after the second strip. Consequently, the resultant metal weld 52 may be formed from a combination of the material of the first strip 102 and the material of the second strip 104. More specifically, the resultant weld may include a small buffering layer formed from the first strip 102 and the remaining weld 52 may be formed from a desired mix or composition of the first strip 102 and the second strip 104. Throughout this process, a layer 62 of pulverized flux protects the leading edge of the molten slag pool 56.

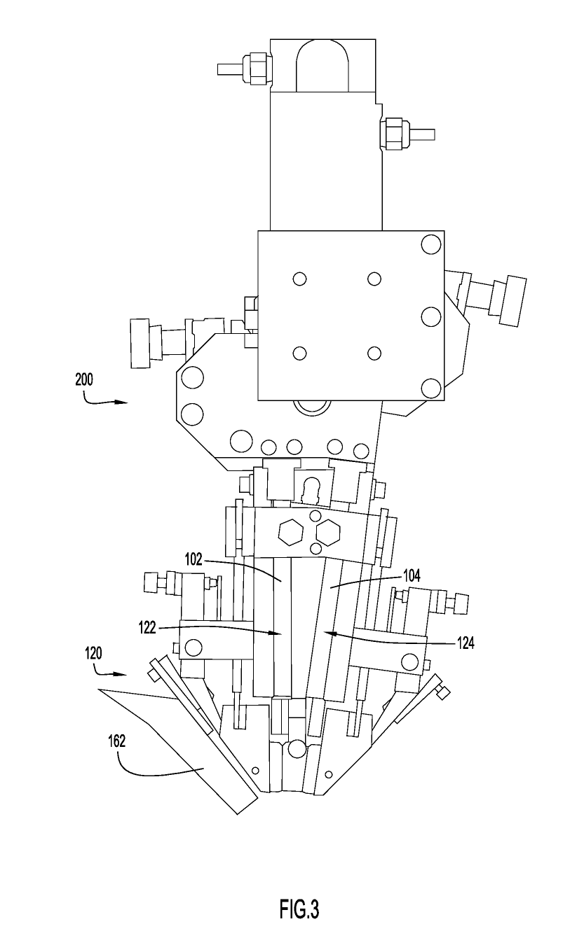

Now turning to FIG. 3, for a description of an example twin ESSC apparatus 200 (i.e., a cladding head 200) with which the techniques described herein can be utilized. In FIGS. 1 and 2, the leading edge is illustrated on the right, whereas in FIG. 3 the leading edge is illustrated on the left (i.e., FIGS. 1 and 2 illustrate an apparatus from the right side and FIG. 3 illustrates the apparatus from the left side); however, the embodiments are otherwise largely the same. Consequently, apparatus 200 has been labeled with the at least some of the same reference numerals used in FIGS. 1 and 2 to illustrate how the features of apparatus 200 correspond to the features discussed above. For example, the apparatus 200 includes a contact jaw 120 configured to receive a leading strip 102 and a trailing strip 104. More specifically, the cladding head 200 includes a leading passage 122 configured to receive and guide the first strip 102 to a work piece and a trailing passage 124 configured to and guide the second strip 102 to the same work piece. The apparatus 200 also includes a flux hopper 162 configured to create a protective layer on the leading edge of the cladding head. In this particular embodiment, the leading passage 122 and the trailing passage 124 are each configured to receive strips of a maximum width of approximately 90 mm and a maximum thickness of approximately 0.5 mm; however in other embodiments, the cladding head 200 may receive strips of any size. The contact jaw 120 is also configured to transfer a current from a power source to the entire surface area of strips 102 and 104 disposed within the leading passage 122 and trailing passage 124.

Now turning to FIG. 4, a description is provided of a method 400 for regulating strip feed speed for electroslag welding operations utilizing two or more feed strips. For clarity, the operations depicted in FIG. 4 are described as being performed by a cladding apparatus (i.e., apparatus 110 or 200); however, this is not intended to be limiting and, in other embodiments, these operations may performed, executed, or caused to execute by any entity, such as a controller (i.e., controller 170). Initially, at 402, the apparatus guides a first strip and a second strip towards a work piece. As mentioned, in at least some embodiments (i.e., the depicted embodiments), a single cladding head (i.e., contact jaw 120) guides both strips towards the work piece; however, in other embodiments, a first head may guide the first strip and a second head may guide the second strip. Following this logic, in embodiments with more than two strips, any number of heads may guide the two or more strips towards a work piece in any combination, such as two strips per head, three strips per head, or irregular combinations.

Regardless of how the guiding occurs, at 404, the apparatus transfers current to at least one of the first strip and the second strip to create a molten slag pool on the work piece sufficient for initiation of a cladding phase. More specifically, the apparatus initiates the start-up phase of the ESSC operations by transferring current to the strips to melt flux, one or more of the strips, and the work piece into a molten slag pool, as is described above in connection with FIG. 2. Once the stick out of the molten slag pool (see “S” in FIG. 2) is sufficient, the apparatus 110 begins cladding operations (i.e., begins the cladding phase). As mentioned above, in at least some embodiments, current is transferred to each strip independently, albeit at the same rate, since the jaws of the plating head are connected to the same power sources (and, thus, receive the same current), as is also described in further detail above.

At 406, the apparatus measures (i.e., via sensor(s) 180), a welding parameter associated with the cladding phase. Welding parameters include welding equipment parameters that have a direct influence on the welding/cladding process, such as welding current, welding speed (i.e., the speed of movement in the welding direction D1), leading strip feed speed, and trailing strip feed speed. Additionally or alternatively, the welding parameters may include or be characteristics of the cladding, such as the stick out of the molten slag pool, dilution of the cladding, penetration of the cladding, temperature of the molten slag pool, or other such characteristics. Any welding parameter may be measured based on any data or feedback provided to or gathered by the controller (i.e., provided to the controller by sensors). For example, the motor speed of a feeder feeding the leading strip may be measured to determine the feed speed of the leading strip.

If a welding parameter is dynamic (i.e., changing or adjusting) during ESSC operations, the welding parameter may be referred to as an active welding parameter. Active welding parameters may respond to changes in welding conditions (e.g., changes in the distance between the end of the strip and the molten slag). Active welding parameters may also be related to and adjusted through adjustment of other active welding parameters. For example, adjustment of the feed speed of a leading strip may change the amount of current delivered through that strip. An active welding parameter as defined herein may also be referred to as a variable welding parameter, in contrast to welding parameters that are intended to be maintained at an essentially constant level. Moreover, active welding parameters are sometimes adjusted to maintain one or more non-active welding parameters at an approximately constant level. For example, active welding parameters may be adjusted manually or automatically in response to detected welding condition variations. However, an active welding parameter does not have to be measured at a corresponding strip. For example, a weld current can be measured at a power source connected to a strip.

As some examples, welding power and heat input may be active welding parameters. The welding power can be defined as P=U×I, where P(kJ) is welding power, U(V) is welding voltage and I(A) is welding current. Less energy in the welding process means that there is less excessive energy to heat the slag and melt the strips. Advantageously, the strip feed speed is reduced when there is less energy in the welding process. More energy means that there is more excessive energy to heat the slag pool and melt the strips, and so the strip feed speed (i.e., the leading strip feed speed) is advantageously increased in response to a detected increase in welding power. Consequently, welding power may be an active welding parameter.

The heat input can be defined as: Q=k×((U×I)/v)×10⁻³, where Q (kJ/mm) is the heat input, k (dimensionless) is the thermal efficiency, U(V) is voltage, I(A) is current and v (mm/min) is the welding speed. Here, the welding speed may also be an active welding parameter. The welding speed can be defined as the speed at which a welding head is moved across a work piece surface.

At step 408, the apparatus feeds the first strip towards the molten slag pool at a first variable feed speed based on the measuring of the welding parameter. For example, in some embodiments, feeding the first strip based on the measured welding parameter may be intended to maintain a welding parameter at a set or constant level. This may entail restoring the welding parameter, through adjustment of at least one other welding parameter, to a set level when it diverges from the set level (i.e., as a consequence of an encountered disturbance). That is, the feed speed can be adjusted to restore a welding parameter to a specific level when the welding parameter differs from a set level. However, in some embodiments, two or more active welding parameter values are used to determine a feed speed for the leading strip which, in turn, can be used to determine a feed speed for a trailing strip.

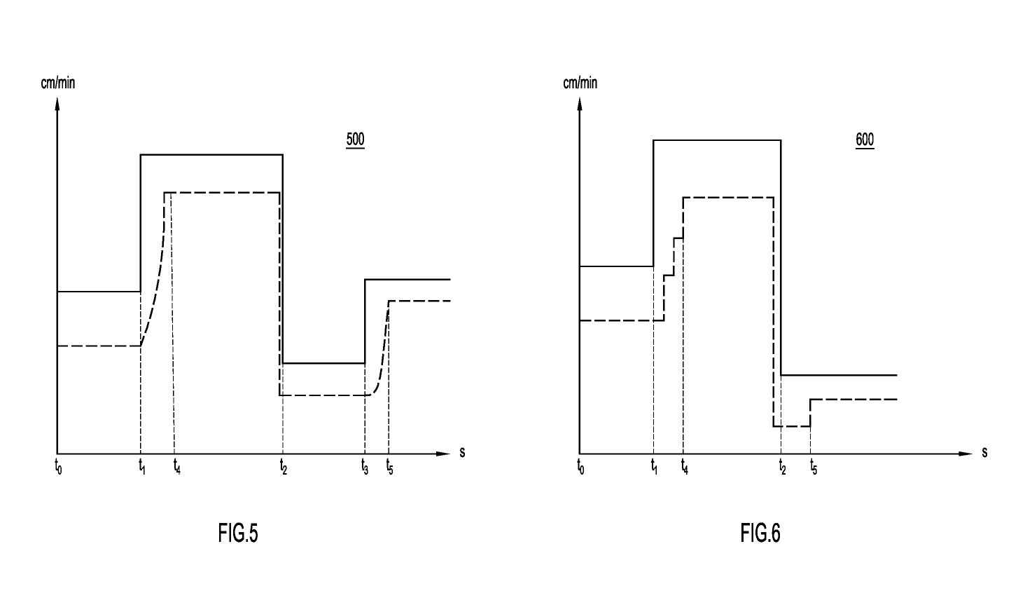

Moreover, since a plurality of parameters can be used as active welding parameters, the techniques presented herein may be compatible with a plurality of different welding processes (i.e., constant amperage (CA), constant feed speed (commonly referred to as CW since CW is frequently referring to constant wire feed speed), constant current (CC), etc.). As one particular example, if ESSC operations run with a constant feed speed (CW), the feed speed of the leading strip is set at a specific rate and the welding current or welding voltage can be automatically adjusted to maintain a voltage or current level. The techniques presented herein may adjust the feed speed of the trailing strip based on welding current variations and, thus, the techniques presented herein may be compatible with CW welding processes. As another example, if ESSC operations are run with a constant amperage (CA), a specific voltage is delivered to the strips. If disturbances are experienced, the current can be adjusted by adjusting the feed speeds of the strips, as is discussed in detail below in connection with FIGS. 5 and 6. The monitoring operations performed at step 404 can monitor for any welding parameters associated with any of these operational modes.

Still referring to FIG. 4, the measuring at step 406 may be constant or continuous (i.e., based on constant or continuous monitoring). To enable this, sensors embedded in or included in the ESSC apparatus may continuously monitor any desirable welding parameters with intervals of about 1 millisecond. For example, sensors may measure the feed speed of the leading strip every millisecond and send or transmit the monitored values to the controller. In at least some embodiments, the controller filters received values to analyze the feed speed of the leading strip. This may result in continuous adjustments to the feed speed of the leading strip at step 408.

At step 410, the apparatus feeds the second strip towards the molten slag pool at a second variable feed speed that is different from the first variable speed, but dynamically determined based on the first variable feed speed. That is, the feed speed of the trailing strip (or any trailing strips) may be determined as a percentage or ratio of the feed speed of the leading strip. For example, the trailing strip may have a feed speed that is any percentage of the feed speed of the leading strip within the range of 50-70%, 30-100%, or even 1-120% (with speeds over 100% indicating that the trailing strip is being fed faster than the leading strip). The percentage or ratio may be based on a predetermined or manually input relationship, an automatically determined relationship, or any other criteria. Regardless of the ratio, the filtered values of the feed speed of the leading strip can be used to determine suitable feed speeds for the trailing strips at intervals having an average length of 0-1,000 ms, preferable 50-250 ms and most preferably 72-125 ms. The feed speed of the trailing strip may also be adjusted based on unfiltered values. As is explained in further detail below (in connection with FIGS. 5 and 6), dynamically determining a feed speed for the trailing strip may also include determining how to adjust the feed speed of the trailing strip (based at least in part on whether the feed speed is to be increased or decreased).

Since the feed speed of the trailing strip is dependent on the feed speed of the leading strip, the feed speed of the trailing strip is dependent on a plurality of active welding parameters. For example, the feed speed of the trailing strip may depend on the welding power, which is dependent on voltage and a welding current that may change over time. Additionally or alternatively, in some embodiments, the feed speed of the trailing strip may dependent on active welding parameters associated with the leading strip and the trailing strip (i.e., parameters that provide an indication of the location of the trailing strip with respect to the molten slag).

At steps 408 and 410 the feed speed can be adjusted in any desirable manner. For example, the controller can transmit a signal to an associated feeder to adjust its feed rate. The signal may adjust the feed speed of the feeders to any desirable speed, but the feed speed of the trailing strip is consistently adjusted to a percentage of the speed of the leading strip. That being said, the feed speeds of both strips may both be referred to as variable because the feed speeds may be constantly changing over time. In fact, as is shown by the loop included in FIG. 4 (from step 410 to step 406), the feed speeds may be constantly and continuously updated based on measured welding parameters. However, the feed speed of the trailing strip need not be updated at the same rate with which the leading strip is monitored. For example, the trailing strip can be updated after a set number of seconds based on measurements taken at millisecond intervals. These updates and adjustments can be fully automatic or semi-automatic. For example, the feed speeds can be automatically adjusted in the manner described below in connection with FIGS. 5 and 6.

Advantageously, automatic adjustment of the feed speeds ensures quick and precise responses to a change in welding conditions. For example, the automatic adjustments may maintain one or more welding parameters at a set level when disturbances, such as stick out variations caused by work piece surface irregularities (as determined based on various welding parameters), variations in the welding process or joint configurations, are encountered. By comparison, if a non-adaptive control welding process (i.e., a twin strip ESSC with constant feed speeds) becomes unstable (e.g., due to welding conditions), the feed speeds of the strips may become unsuitable for the current welding conditions and may increase welding instability. The trailing strip may not contact the molten slag or may not properly contact the molten slag and, thus, the resultant weld may not have the desired composition or quality. Additionally or alternatively, the unadjusted feed rates may result in insufficient deposition rates which may lead to deposition rate variations, weld defects and other undesirable consequences. These problems are avoided when the feed speed of the trailing strip is dependent on the feed speed of the leading strip (which is dependent on one or more active welding parameters) at least because the strip feed speeds are adjusted to better suit current welding conditions. This will improve the quality of the weld during cladding operations and the welding process stability.

Moreover, automatically adjusting the feed speeds allows for fine-tuned control over the weld and/or cladding created during an ESSC process. For example, if strips of different material are used, a weld/cladding layer with a mixed composition can be created. The exact composition (i.e., chemical properties) can be controlled by controlling the feed speed at specific percentages. For example, feeding a second material (the trailing strip) at 50% of the speed of the feed speed of the first material (the leading strip) may create a weld with a first specific composition while feeding the second material (the trailing strip) at 80% of the speed of the feed speed of the first material (the leading strip) may create a weld with a second specific composition. In at least some embodiments, the second or trailing strip is a more expensive material and the techniques presented herein ensure that the second strip is introduced only when needed. For example, the more expensive trailing strip is not used to form a buffer layer of the weld. This may reduce the cost of the ESSC operations.

Moreover, in at least some embodiments, adjusting the feed speeds of multiple strips with the techniques presented herein may ensure that the second strip corrects any errors or flaws included in the weld deposit of the first strip. This may ensure that cladding operations can be completed in a single pass and may significantly increase the speed of cladding operations. For example, ESSC operations performed with the techniques presented herein may be provide a 50%-100% increase in welding speed as compared to single strip ESSC.

Now referring to FIGS. 5 and 6 for a description of two diagrams 500 and 600 that illustrate exemplary and alternative embodiments of methods for controlling an ESSC process with multiple strips. For clarity, diagram 500 and diagram 600 each illustrate the feed speed of a single trailing strip being adjusted based on the feed speed of a single leading strip over time (with feed speed shown in cm/min); however, the feed speed of one or more trailing strips can be adjusted based on the feed speed of a leading strip over time. The solid lines included in diagrams 500 and 600 represent the feed speed of the leading strip while the dashed lines represent the feed speed of the trailing strip.

Moreover, diagrams 500 and 600 illustrate feed speed adjustments that are effectuated while the power sources are operating with an approximately constant voltage (i.e., constant amperage (CA)). However, the example adjustments described in connection with FIGS. 5 and 6 can also be applied to welding process operating with constant current (CC), to maintain a constant strip feed speed for ESSC operations operating with constant strip feed speed (CW), or any other welding processes. Additionally, the feed speed curves shown in FIGS. 5 and 6 are not exact representations of suitable strip feed speed variations and, instead, are simply intended to generally illustrate the techniques presented herein.

That being said, in diagrams 500 and 600, the leading strip feed speed is continuously measured and the measured values are filtered in the controller. For each filtered value, the controller determines a corresponding feed speed target value for the trailing strip and controls or instructs the feeder for the trailing strip to adjust the feed speed of the trailing strip to the target value. The target value is generally determined based on a ratio or percentage of the trailing strip feed speed to the leading strip feed speed. The ratio or percentage may be predetermined, manually entered, and/or dynamically determined. As examples, the trailing strip may have a feed speed that is any percentage of the feed speed within the range of 50-70%, 30-100%, or even 1-120% (with speeds over 100% indicating that the trailing strip is being fed faster than the leading strip).

The controller also compares the target value to the current feed speed of the trailing strip to determine how to adjust the feed speed of the trailing strip (i.e., immediately (in “real-time”) or with a delay), as is described below. Generally, decreases in the feed speed of the trailing strip are implemented in real-time while increases are implemented with a delay, such as a 100 ms-500 ms delay. For example, the time delay can be dependent on the size of the leading strip feed speed increase (i.e., the difference between the target value and the current value). The time delay can be defined as the time period between the detection of an active welding parameter value and the initiation of a trailing strip feed speed change caused by the detected active welding parameter value. Should the active welding parameter change again before the trailing strip feed speed has reached its target value, then another target value for the trailing strip feed speed is determined and the trailing strip feed speed is adjusted accordingly.

As a more specific example, in diagram 500, initially, the feed speed of the leading strip is essentially constant (t₀-t₁). Then, at time t₁, there is a disturbance, and the welding current transferred through the leading strip drops. In order to restore the welding current to its previous value, the welding apparatus increases the feed speed of the leading strip (at time t₁) to correct for the disturbance (i.e., to ensure the leading strip remains disposed within the molten slag pool). Shortly thereafter, at time t₂, there is an increase of the welding current (i.e., due to another disturbance that, for examples, moves too much of the leading strip into the molten slag pool). Consequently, the feed speed of the leading strip speed is reduced, to restore the welding current to its previous value. At time t₃, welding current is reduced again and, thus, the feed speed of the leading strip is increased to maintain the welding current at an essentially constant level over time.

During these adjustments, the feed speed of the trailing strip is adjusted based on the feed speed of the leading strip to maintain the feed speed of the trailing strip at a speed that is a certain percentage of the feed speed of the leading strip (as shown by the dashed line in FIG. 5). In particular, at time t₁, the controller determines a first target value for the trailing strip based on the increased speed of the leading strip (as determined based on feedback or data produced by sensors constantly monitoring the feed speed of the leading strip). The controller also compares the first target value to the current feed speed of the trailing strip. The comparison reveals that the first target value is higher than the current feed speed and, thus, the controller determines a suitable gradient for the increase of the feed speed of the trailing strip. Thereafter, the controller causes the feeder for the trailing strip to slowly increase the feed speed of the trailing strip, over a time period spanning from time t1 to time t4, to the first target value. The time delay (i.e., the time span from time t₁ to time t₄) prevents the trailing strip from being pushed too far down in the molten slag puddle. The controller may slowly increase the trailing strip feed speed with any curve or gradient. In one example, the slope of the gradient may decrease as the trailing strip feed speed approaches its target value.

At time t₂ the controller determines a second target value for the trailing strip based on the decreased speed of the leading strip (as determined based on feedback or data produced by sensors constantly monitoring the feed speed of the leading strip). The controller also compares the second target value to the current feed speed of the trailing strip (which is the first target value at time t₂). Based on the comparison (which indicates that the second target value is lower than the current speed at time t₂), the controller immediately causes the feeder for the trailing strip to decrease the feed speed of the trailing strip. This feed speed reduction is implemented immediately to prevent the trailing strip from exiting the molten slag puddle (i.e., prevent the strip from being disposed above the molten slag).

Finally, at time t₃, the controller determines a third target value for the trailing strip based on the increased speed of the leading strip (as determined based on feedback or data produced by sensors constantly monitoring the feed speed of the leading strip). The controller also compares the third target value to the current feed speed of the trailing strip (which is the second target value at time t₃). The comparison reveals that the first target value is higher than the current feed speed and, thus, the controller determines a suitable gradient for the increase of the feed speed of the trailing strip and adjusts the feed speed of the trailing strip in the same manner discussed above with respect to the increase to the first target value.

In diagram 600, the feed speed for the leading strip is nearly identical to the feed speed of the leading strip in FIG. 5 (except that the leading strip feed speed remains constant after the reduction at time t₂). The difference between diagrams 500 and 600 is that the feed speed of the trailing strip is adjusted in steps in diagram 600. In particular, at time t₁, when the controller determines that the feed speed of the leading strip has increased (and determines a target value for the trailing strip that is higher than the current feed speed of the trailing strip), the controller determines a step function for increasing the feed speed of the trailing strip (so that the trailing strip is fed at its target value after a delay spanning from time t₁ to time t₄). Then, when the controller determines that the feed speed of the leading strip has decreased (and determines a target value for the trailing strip that is lower than the current feed speed of the trailing strip), the controller causes the feeder for the trailing strip to decrease the feed speed of the trailing strip to a value below the target value and approach the target value in accordance with a step function (so that the trailing strip reaches its target value after a delay spanning from time t₂ to time t₅ of FIG. 6).

In different embodiments, the steps may have varying length (ms) and/or height (cm/min). For example, the steps may be shorter and higher as the feed speed of the trailing strip approaches its target value, or, alternatively, be shorter and higher when an adjustment of the feed speed of the trailing strip is initiated. Of course, the adjustments of the trailing strip feed speed may also be carried out in steps having a constant length (ms) and/or a constant height (cm/min). The steps are advantageously executed with intervals of between 10-1000 ms, preferably between 50-500 ms and most preferably 75-125 ms until the feed speed of the trailing strip reaches its target value. Moreover, the feed speed of the trailing strip may be increased in steps of up to 100 cm/min, preferably between 1-10 cm/min and most preferably between 4-6 cm/min, until it reaches its target value. It is possible to use smaller steps than 1 cm/min, for example when the difference between the target value and the present trailing strip feed speed value is less than 1 cm/min. When the feed speed is decreased, the step functions may start from a value lower than the target value to ensure system stability.

Now referring to FIG. 7 for a description of a computer system 701 upon which the techniques presented herein may be implemented. The computer system 701 may be representative of the controller 170 illustrated in FIG. 1.

The computer system 701 includes a bus 702 or other communication mechanism for communicating information, and a processor 703 coupled with the bus 702 for processing the information. While the figure shows a single block 703 for a processor, it should be understood that the processors 703 represent a plurality of processing cores, each of which can perform separate processing. The computer system 701 also includes a main memory 704, such as a random access memory (RAM) or other dynamic storage device (e.g., dynamic RAM (DRAM), static RAM (SRAM), and synchronous DRAM (SD RAM)), coupled to the bus 702 for storing information and instructions to be executed by processor 703. In addition, the main memory 704 may be used for storing strip feed speed regulation module 174 (see FIG. 1), or at least a portion thereof, temporary variables or other intermediate information during the execution of instructions by the processor 703.

The computer system 701 further includes a read only memory (ROM) 705 or other static storage device (e.g., programmable ROM (PROM), erasable PROM (EPROM), and electrically erasable PROM (EEPROM)) coupled to the bus 702 for storing static information and instructions for the processor 703. For example, ROM 705 may be used for storing strip feed speed regulation module 174 (see FIG. 1), or at least a portion thereof. Memory 704 and/or ROM 705 may be representative of memory 172 from FIG. 1.

The computer system 701 also includes a disk controller 706 coupled to the bus 702 to control one or more storage devices for storing information and instructions, such as a magnetic hard disk 707, and a removable media drive 708 (e.g., floppy disk drive, read-only compact disc drive, read/write compact disc drive, tape drive, and removable magneto-optical drive, optical drive). The storage devices may be added to the computer system 701 using an appropriate device interface (e.g., small computer system interface (SCSI), integrated device electronics (IDE), enhanced-IDE (E-IDE), direct memory access (DMA), or ultra-DMA).

The computer system 701 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)), that, in addition to microprocessors and digital signal processors may individually, or collectively, are types of processing circuitry. The processing circuitry may be located in one device or distributed across multiple devices.

The computer system 701 may also include a display controller 709 coupled to the bus 702 to control a display 710, such as liquid crystal display (LCD), or a light emitting diode (LED) display, for displaying information to a computer user. The computer system 701 includes input devices, such as a keyboard 711 and a pointing device 712, for interacting with a computer user and providing information to the processor 703. The pointing device 712, for example, may be a mouse, a trackball, or a pointing stick for communicating direction information and command selections to the processor 703 and for controlling cursor movement on the display 710. The pointing device 712 may also be incorporated into the display device as, for example, a capacitive touchscreen and/or a resistive touchscreen.

The computer system 701 performs a portion or all of the processing steps of the invention in response to the processor 703 executing one or more sequences of one or more instructions contained in a memory, such as the main memory 704. Such instructions may be read into the main memory 704 from another computer readable medium, such as a hard disk 707 or a removable media drive 708. One or more processors in a multi-processing arrangement may also be employed to execute the sequences of instructions contained in main memory 704. In alternative embodiments, hard-wired circuitry may be used in place of or in combination with software instructions. Thus, embodiments are not limited to any specific combination of hardware circuitry and software.

As stated above, the computer system 701 includes at least one computer readable medium or memory for holding instructions programmed according to the embodiments presented, for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SD RAM, or any other magnetic medium, compact discs (e.g., CD-ROM), or any other optical medium, punch cards, paper tape, or other physical medium with patterns of holes, or any other medium from which a computer can read.

Stored on any one or on a combination of non-transitory computer readable storage media, embodiments presented herein include software for controlling the computer system 701, for driving a device or devices for implementing the invention, and for enabling the computer system 701 to interact with a human user (e.g., a network engineer). Such software may include, but is not limited to, device drivers, operating systems, development tools, and applications software. Such computer readable storage media further includes a computer program product for performing all or a portion (if processing is distributed) of the processing presented herein.

The computer code devices may be any interpretable or executable code mechanism, including but not limited to scripts, interpretable programs, dynamic link libraries (DLLs), Java classes, and complete executable programs. Moreover, parts of the processing may be distributed for better performance, reliability, and/or cost.

The computer system 701 also includes a communication interface 713 coupled to the bus 702. The communication interface 713 provides a two-way data communication coupling to a network link 714 that is connected to, for example, a local area network (LAN) 715, or to another communications network 716 such as the Internet. For example, the communication interface 713 may be a wired or wireless network interface card to attach to any packet switched (wired or wireless) LAN. As another example, the communication interface 713 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 713 sends and receives electrical, electromagnetic or optical signals that carry digital data streams representing various types of information.

The network link 714 typically provides data communication through one or more networks to other data devices. For example, the network link 714 may provide a connection to another computer through a local area network 715 (e.g., a LAN) or through equipment operated by a service provider, which provides communication services through a communications network 716. The local network 714 and the communications network 716 use, for example, electrical, electromagnetic, or optical signals that carry digital data streams, and the associated physical layer (e.g., CAT 5 cable, coaxial cable, optical fiber, etc.). The signals through the various networks and the signals on the network link 714 and through the communication interface 713, which carry the digital data to and from the computer system 701 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 701 can transmit and receive data, including program code, through the network(s) 715 and 716, the network link 714 and the communication interface 713. Moreover, the network link 714 may provide a connection through a LAN 715 to a mobile device 717 such as a personal digital assistant (PDA) laptop computer, or cellular telephone.

To summarize, in one form, a method is provided comprising: guiding a first strip and a second strip towards a work piece; transferring a current to at least one of the first strip and the second strip to create a molten slag pool on the work piece sufficient for initiation of a cladding phase; measuring a welding parameter associated with the cladding phase; feeding the first strip towards the molten slag pool at a first variable feed speed based on the measuring of the welding parameter; and feeding the second strip towards the molten slag pool at a second variable feed speed that is different from the first variable speed, but dynamically determined based on the first variable feed speed.

In another form, an apparatus is provided comprising: a first strip feeder configured to guide a first strip towards a work piece; a second strip feeder configured to guide a second strip towards the work piece; a power source configured to transfer a current to at least one of the first strip and the second strip to create a molten slag pool on the work piece sufficient for initiation of a cladding phase; and a controller configured to: measure a welding parameter associated with the cladding phase; cause the first strip feeder to feed the first strip towards the molten slag pool at a first variable feed speed based on the measuring of the welding parameter; and cause the second strip feeder to feed the second strip towards the molten slag pool at a second variable feed speed that is different from the first variable speed, but dynamically determined based on the first variable feed speed.

In yet another form, one or more non-transitory computer-readable storage media is provided encoded with software comprising computer executable instructions and when the software is executed operable to: cause a first strip feeder to guide a first strip towards a work piece; cause a second strip feeder to guide a second strip towards the work piece; cause a power source to transfer a current to at least one of the first strip and the second strip to create a molten slag pool on the work piece sufficient for initiation of a cladding phase; measure a welding parameter associated with the cladding phase; cause the first strip feeder to feed the first strip towards the molten slag pool at a first variable feed speed based on the measuring of the welding parameter; and cause the second strip feeder to feed the second strip towards the molten slag pool at a second variable feed speed that is different from the first variable speed, but dynamically determined based on the first variable feed speed.

Although the techniques are illustrated and described herein as embodied in one or more specific examples, the specific details of the examples are not intended to limit the scope of the techniques presented herein, since various modifications and structural changes may be made within the scope and range of the invention. In addition, various features from one of the examples discussed herein may be incorporated into any other examples. Accordingly, the appended claims should be construed broadly and in a manner consistent with the scope of the disclosure.

We claim:

1. A method for electroslag welding, comprising:
guiding a first strip and a second strip towards a work piece;
transferring a current to at least one of the first strip and the second strip to create a molten slag pool on the work piece sufficient for initiation of a cladding phase;
measuring a welding parameter associated with the cladding phase;
feeding the first strip towards the molten slag pool at a first variable feed speed based on the measuring of the welding parameter; and
feeding the second strip towards the molten slag pool at a second variable feed speed that is different from the first variable speed, but dynamically determined based on the first variable feed speed.

2. The method for electroslag welding of claim 1, wherein the guiding further comprises:
guiding the first strip and the second through a contact jaw towards the work piece.

3. The method for electroslag welding of claim 2, wherein:
feeding the first strip comprises feeding the first strip through the contact jaw with a first feeder; and
feeding the second strip comprises feeding the second strip through the contact jaw with a second feeder.

4. The method for electroslag welding of claim 1, wherein the first strip is a first material, the second strip is a second material, and wherein:
feeding the first strip at the first variable speed and feeding the second strip at the second variable speed creates a weld with a composition that is a mix of the first material and the second material.

5. The method for electroslag welding of claim 1, further comprising:
continuously determining target values for the second variable speed; and
continuously adjusting the second variable speed to the target values.

6. The method for electroslag welding of claim 5, wherein an increase in consecutive target values is translated to the second variable speed with a time delay via a gradient increase or a stepped increase.

7. The method for electroslag welding of claim 5, wherein a decrease in consecutive target values is translated to the second variable speed immediately.

8. An apparatus comprising:
a first strip feeder to guide a first strip towards a work piece;
a second strip feeder to guide a second strip towards the work piece;
a power source to transfer a current to at least one of the first strip and the second strip to create a molten slag pool on the work piece sufficient for initiation of a cladding phase; and
a controller to:
measure a welding parameter associated with the cladding phase;
cause the first strip feeder to feed the first strip towards the molten slag pool at a first variable feed speed based on the measuring of the welding parameter; and
cause the second strip feeder to feed the second strip towards the molten slag pool at a second variable feed speed that is different from the first variable speed, but dynamically determined based on the first variable feed speed.

9. The apparatus of claim 8, further comprising:
a contact jaw disposed adjacent the molten slag pool, wherein the first strip feeder and the second strip feeder are configured to guide the first strip and the second through the contact jaw towards the work piece.

10. The apparatus of claim 9, wherein the contact jaw includes a first passage and a second passage, and wherein:
the first strip feeder is configured to feed the first strip through the first passage; and
the second strip feeder is configured to feed the second strip through the second passage.

11. The apparatus of claim 8, wherein the first strip is a first material, the second strip is a second material, and wherein:
feeding the first strip at the first variable speed and feeding the second strip at the second variable speed creates a weld with a composition that is a mix of the first material and the second material.

12. The apparatus of claim 8, wherein the controller is further configured to:
continuously determine target values for the second variable speed; and
continuously adjust the second variable speed to the target values.

13. The apparatus of claim 12, wherein an increase in consecutive target values is translated to the second variable speed with a time delay via a gradient increase or a stepped increase.

14. The apparatus of claim 12, wherein a decrease in consecutive target values is translated to the second variable speed immediately.

15. One or more non-transitory computer readable storage media encoded with software comprising computer executable instructions and when the software is executed operable to:
cause a first strip feeder to guide a first strip towards a work piece;
cause a second strip feeder to guide a second strip towards the work piece;
cause a power source to transfer a current to at least one of the first strip and the second strip to create a molten slag pool on the work piece sufficient for initiation of a cladding phase;
measure a welding parameter associated with the cladding phase;
cause the first strip feeder to feed the first strip towards the molten slag pool at a first variable feed speed based on the measuring of the welding parameter; and
cause the second strip feeder to feed the second strip towards the molten slag pool at a second variable feed speed that is different from the first variable speed, but dynamically determined based on the first variable feed speed.

16. The one or more non-transitory computer readable storage media of claim 15, wherein the computer executable instructions operable to cause the first strip feeder and the second strip feeder to guide the first strip and the second strip towards the work piece are further operable to:
cause the first strip feeder and the second strip feeder to guide the first strip and the second through a contact jaw towards the work piece.

17. The one or more non-transitory computer readable storage media of claim 15, wherein the first strip is a first material, the second strip is a second material, and wherein:
feeding the first strip at the first variable speed and feeding the second strip at the second variable speed creates a weld with a composition that is a mix of the first material and the second material.

18. The one or more non-transitory computer readable storage media of claim 15, further comprising instructions operable to:
continuously determine target values for the second variable speed; and
continuously adjust the second variable speed to the target values.

19. The one or more non-transitory computer readable storage media of claim 18, wherein an increase in consecutive target values is translated to the second variable speed with a time delay via a gradient increase or a stepped increase.

20. The one or more non-transitory computer readable storage media of claim 18, wherein a decrease in consecutive target values is translated to the second variable speed immediately.
